(19) United States
(12) Patent Application Publication
(10) Pub. No.: US 2006/0154089 A1
(43) Pub. Date: Jul. 13, 2006

(54) Optical coatings for ultraviolet and infrared reflection

(76) Inventor: Pill-Hwan Jung, Seoul (KR)

Correspondence Address: SHERIDAN ROSS PC, 1560 BROADWAY, SUITE 1200, DENVER, CO, 80202, US

(21) Appl. No.: 10/539,855

(22) PCT Filed: Dec. 17, 2003
(86) PCT No.: PCT/KR03/02759

§ 371 Date: Dec. 18, 2005

(30) Foreign Application Priority Data
Dec. 20, 2002 (KR) 10-2002-0081628

(51) Int. Cl. B32B 17/06; B32B 15/04; B32B 9/00; B32B 19/00

(52) U.S. Cl. 428/432; 428/469; 428/701; 428/472; 428/702

(57) ABSTRACT

A multilayer structure for shading ultraviolet and infrared light includes two or three layers of Ag; two or three layers of indium tin oxide (ITO); and dielectric oxide layers ranging from two layers to four layers. At least two Ag layers are formed to be in contact with the ITO layers as an upward or downward layer. Each dielectric oxide layer is made of a material which is selected from SiO₂, TiO₂, Al₂O₃, ZrO₂, Y₂O₃ and Ta₂O₅. The structure effectively shades ultraviolet and infrared light while transmitting visible light with a transmittance more than 85%.

### BACKGROUND OF THE INVENTION

(a) Field of the Invention

The present invention relates to coatings for ultraviolet and infrared reflection, and more particularly to multilayer structures which transmit visible light while effectively shading ultraviolet and infrared light with a plurality of layers having different refractive indices. More particularly, the present invention relates to window constructions on which the multilayer structure is formed.

(b) Description of the Related Art

Generally, ultraviolet light of a wavelength ranging between 10-400 nm may cause skin aging, eye fatigue, or cataracts in human bodies, and decolorization in articles, while infrared light of a wavelength ranging over 700 nm may generate heat causing the ambient temperature to rise. Human bodies and indoor articles may be damaged by ultraviolet light, specifically in vehicles or buildings in which windows take up much area. In summer time, the cost for air cooling is increased due to temperature rising because of infrared light.

In order to shade ultraviolet or infrared light, a color plastic sheet or a metal coating material may be applied to windows. Since the color plastic sheet or metal coating material shades visible light as well as ultraviolet and infrared light, however, it may cause full visibility or forward observation capability to be reduced, especially when driving. It may also cause indoor lighting to be insufficient.

A multilayer structure for shading infrared light has been developed as disclosed in Korean Patent Publication No. 1988-10930A to shade infrared light from sunlight, but the structure can merely reflect infrared light having a limited wavelength range of 900-1200 nm. The structure can shade neither infrared light having wavelengths over 1200 nm, nor ultraviolet and infrared light simultaneously.

### SUMMARY OF THE INVENTION

In view of the prior art described above, it is an object of the present invention to provide a multilayer structure for shading both ultraviolet and infrared light effectively as well as for transmitting visible light, and a window construction in which the structure is formed.

It is another object of the present invention to provide a multilayer structure with a plurality of materials having different refractive indices and different thicknesses for shading both ultraviolet and infrared light effectively, and a window construction in which the structure is formed.

It is still another object of the present invention to provide articles including safety glass for vehicles which shade both ultraviolet and infrared light.

To achieve these and other objects, as embodied and broadly described herein, a multilayer structure for shading ultraviolet and infrared light includes two or three layers of Ag; two or three layers of indium tin oxide (ITO); and dielectric oxide layers ranging from two layers to four layers. At least two Ag layers are formed to be in contact with the ITO layer as an upward or downward layer. Each dielectric oxide layer is made of a material which is selected from SiO₂, TiO₂, Al₂O₃, ZrO₂, Y₂O₃, and Ta₂O₅.

According to another aspect to the present invention, a window construction for ultraviolet and infrared shading includes a substrate of glass or plastic material;

two or three layers of Ag; two or three layers of indium tin oxide (ITO); and dielectric oxide layers ranging from two layers to four layers. At least two Ag layers are formed to be in contact with the ITO layer as an upward or downward layer.

The multilayer structure according to the present invention is formed by stacking a plurality of layers of coating materials having different refractive indices on a substrate of glass or a plastic such as acryl. Each layer of the structure can be deposited by a vapor deposition method such as physical vapor deposition (PVD) or chemical vapor deposition (CVD). The design of the structure employs multiple reflection, which occurs in each thin layer that is made of a coating material different from the others, in order to selectively reflect or transmit light having particular wavelength ranges. Each coating material is selected while taking its refractive index and optical properties into consideration, and the deposition thickness of each layer is determined while considering generation of multiple reflection for the desired wavelength ranges.

The present invention employs silver (Ag), indium tin oxide (ITO), and dielectric oxides as coating materials.

Silver (Ag) has good optical transmission properties for visible light and good reflection properties in infrared ranges. The thickness of the Ag layer preferably ranges from 5 nm to 15 nm.

Indium tin oxide (ITO) is an oxide of indium and tin, in which a ratio of In₂O₃ to SnO₂ ranges from 85:15 to 95:4. ITO has good optical transmission of more than 80% for visible light, independent of a deposited thickness.

The dielectric oxide is preferably selected from SiO₂, TiO₂, Al₂O₃, ZrO₂, Y₂O₃, and Ta₂O₅, and its thickness is determined according to each refractive index.

### BRIEF DESCRIPTION OF THE DRAWINGS

FIG. 1 is a graph of wavelength of incident light versus percent transmission of incident light through an optical coating according to a first embodiment of the present invention;

FIG. 2 is a graph of wavelength of incident light versus percent transmission of incident light through an optical coating according to a second embodiment of the present invention;

FIG. 3 is a graph of wavelength of incident light versus percent transmission of incident light through an optical coating according to a third embodiment of the present invention;

FIG. 4 is a graph of wavelength of incident light versus percent transmission of incident light through an optical coating according to a fourth embodiment of the present invention;

FIG. 5 is a graph of wavelength of incident light versus percent transmission of incident light through an optical coating according to a fifth embodiment of the present invention;

FIG. 6 is a graph of wavelength of incident light versus percent transmission of incident light through an optical coating according to a sixth embodiment of the present invention; and

FIG. 7 shows a cross-sectional view of a car window with the multilayer structure of the present invention.

### DETAILED DESCRIPTION OF THE PREFERRED EMBODIMENTS

Preferred embodiments of the present invention will hereinafter be described in detail with reference to the accompanying drawings.

### First Embodiment

A multilayer structure for shading ultraviolet and infrared light according to the first embodiment of the present invention has seven layers, employing four coating materials such as Ag, ITO, SiO₂, and TiO₂.

The arrangement, refractive indices, and thicknesses of coating materials are listed in Table 1 below in order from a substrate.

TABLE 1

| | | Refractive Index (reference | Layer |
|---|---|---|---|
| NO. | Material | wavelength 510 nm) | thickness(nm) |
| 7 | TiO₂ | 2.34867 | 28.81 |
| 6 | Ag | 0.051 | 14.38 |
| 5 | ITO | 2.058 | 84.63 |
| 4 | Ag | 0.051 | 8.07 |
| 3 | TiO₂ | 2.34867 | 126.06 |
| 2 | ITO | 2.058 | 38.14 |
| 1 | SiO₂ | 1.4618 | 162.79 |
| Substrate | Glass | 1.52077 | |

As shown in Table 1, the multilayer structure may employ four coating materials to form a seven-layer structure. Specifically, the fifth layer of ITO is embedded between the fourth layer of Ag and the sixth layer of Ag.

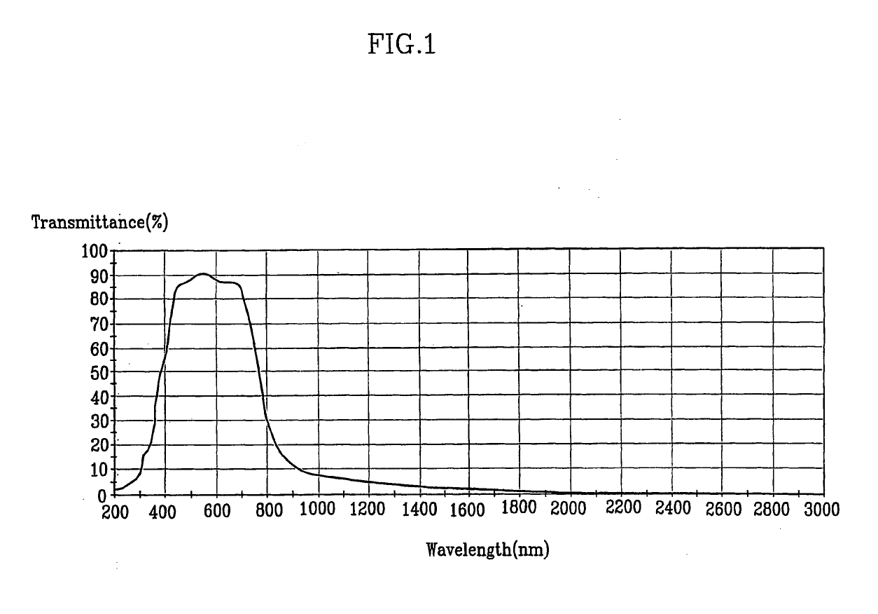

The shading of ultraviolet and infrared light in the multilayer structure is shown in FIG. 1, which illustrates a graph of transmission percent of incident light versus the wavelength of the incident light. The multilayer structure transmits about 1.77% of light having a wavelength of 200 nm and about 8% of light having a wavelength of 300 nm, to shade ultraviolet light, while it transmits more than 85% of visible light. Further, the transmittance of the structure is about 31% at a wavelength of 800 nm and is then reduced to less than 8% at a wavelength of 1000 nm, resulting in effective shading of the whole infrared range.

### Second Embodiment

A multilayer structure for shading ultraviolet and infrared light according to the. second embodiment of the present invention has seven layers, employing three coating materials such as Ag, ITO, and Y₂O₃.

The arrangement, refractive. indices, and thicknesses of coating materials are listed in Table 2 below in order from a substrate.

TABLE 2

| | | Refractive Index (reference | Layer |
|---|---|---|---|
| NO. | Material | wavelength 510 nm) | Thickness(nm) |
| 7 | Y₂O₃ | 1.79581 | 4.08 |
| 6 | ITO | 2.058 | 36.14 |
| 5 | Ag | 0.051 | 12.82 |
| 4 | ITO | 2.058 | 71.91 |
| 3 | Ag | 0.051 | 9.39 |
| 2 | Y₂O₃ | 1.79581 | 85.56 |
| 1 | Ag | 0.051 | 5.79 |
| Substrate | Glass | 1.52077 | |

As shown in Table 2, the multilayer structure may employ three coating materials to form a seven-layer structure. Specifically, the third layer of Ag and fifth layer of Ag are alternatively formed with the fourth layer of ITO and the sixth layer of ITO.

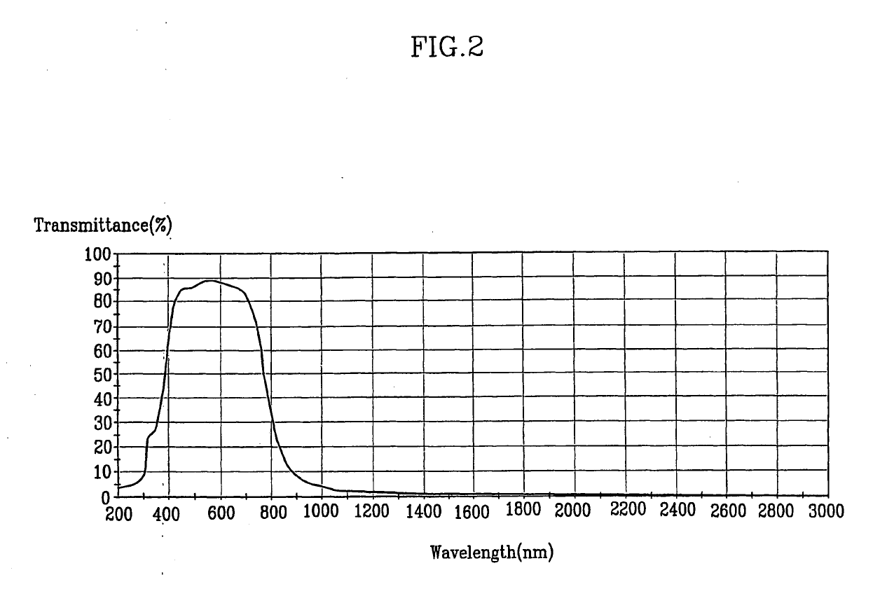

The shading of ultraviolet and infrared light in the multilayer structure is shown in FIG. 2, which illustrates a graph of transmission percent of incident light versus the wavelength of the incident light. The multilayer structure transmits about 3.5% of light having a wavelength of 200 nm and about 9.5% of light having a wavelength of 300 nm, to shade ultraviolet light, while it transmits more than 85% of visible light. Further, the transmittance of the structure is about 32% at a wavelength of 800 nm and then is reduced to less than 4% at a wavelength of 1000 nm, resulting in effective shading of the whole infrared range.

### Third Embodiment

A multilayer structure for shading ultraviolet and infrared light according to the third embodiment of the present invention has seven layers, employing three coating materials such as Ag, ITO, and ZrO₂.

The arrangement, refractive indices, and thicknesses of coating materials are listed in Table 3 below in order from a substrate.

TABLE 3

| | | Refractive Index (reference | Layer |
|---|---|---|---|
| NO. | Material | wavelength 510 nm) | Thickness(nm) |
| 7 | ZrO₂ | 2.06576 | 9.58 |
| 6 | ITO | 2.058 | 29.57 |
| 5 | Ag | 0.051 | 13.07 |
| 4 | ITO | 2.058 | 76.34 |
| 3 | Ag | 0.051 | 10.05 |
| 2 | ZrO₂ | 2.06576 | 63.84 |
| 1 | Ag | 0.051 | 5.6 |
| Substrate | Glass | 1.52077 | |

As shown in Table 3, the multilayer structure may employ three coating materials to form a seven-layer structure. Specifically, the third layer of Ag and fifth layer of Ag are alternatively formed with the fourth layer of ITO and the sixth layer of ITO.

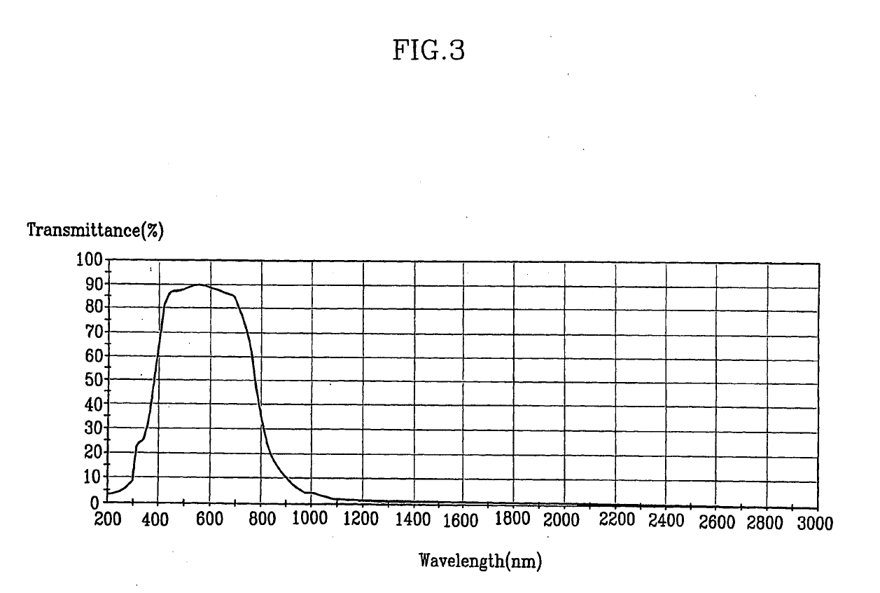

The shading of ultraviolet and infrared light in the multilayer structure is shown in FIG. 3, which illustrates a graph of transmission percent of the incident light versus the wavelength of the incident light thereof. The multilayer structure transmits about 3.2% of light having a wavelength of 200 nm and about 9.7% of light having a wavelength of 300 nm, to shade ultraviolet light, while it transmits more than 85% of visible light. Further, the transmittance of the structure is about 32.5% at a wavelength of 800 nm, and is then reduced to less than 9% at a wavelength of 1000 nm, resulting in effective shading of the whole infrared range.

### Fourth Embodiment

A multilayer structure for shading ultraviolet and infrared light according to the fourth embodiment of the present invention has eight layers, employing four coating materials such as Ag, ITO, SiO₂, and Ta₂O₅.

The arrangement, refractive indices, and thicknesses of coating materials are listed in Table 4 below in order from a substrate.

TABLE 4

| | | Refractive Index (reference | Layer |
|---|---|---|---|
| NO. | Material | wavelength 510 nm) | Thickness(nm) |
| 8 | Ta₂O₅ | 2.14455 | 35 |
| 7 | Ag | 0.051 | 13.38 |
| 6 | ITO | 2.058 | 79.89 |
| 5 | Ag | 0.051 | 11.06 |
| 4 | Ta₂O₅ | 2.14455 | 72.4 |
| 3 | Ag | 0.051 | 10.76 |
| 2 | ITO | 2.058 | 34.18 |
| 1 | SiO₂ | 1.4618 | 103.67 |
| Substrate | Glass | 1.52077 | |

As shown in Table 4, the multilayer structure may employ four coating materials to form an eight-layer structure. Specifically, the third layer of Ag is formed on the second layer of ITO, and the sixth layer of ITO is embedded in the fifth layer of Ag and the seventh layer of Ag.

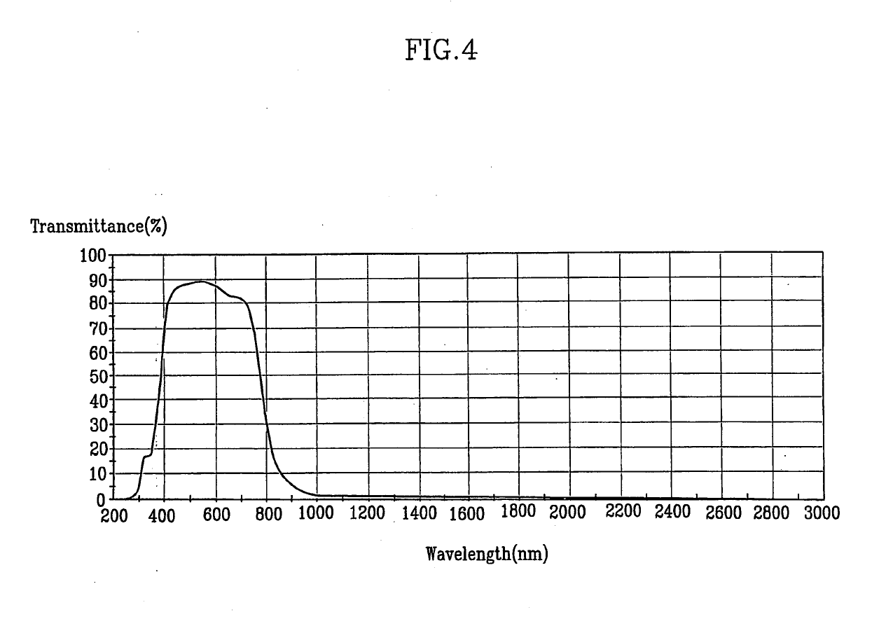

The shading of ultraviolet and infrared light in the multilayer structure is shown in FIG. 4, which illustrates a graph of transmission percent of the incident light versus the wavelength of the incident light thereof. The multilayer structure transmits about 0.08% of light having a wavelength of 200 nm and about 6.8% of light having a wavelength of 300 nm, to shade ultraviolet light, while it transmits more than 85% of visible light. Further, the transmittance of the structure is about 29% at a wavelength of 800 nm and is then reduced to less than 2% at a wavelength of 1000 nm, resulting in effective shading of the whole infrared range.

### Fifth Embodiment

A multilayer structure for shading ultraviolet and infrared light according to the fifth embodiment of the present invention has nine layers, employing four coating materials such as Ag, ITO, SiO₂, and Al₂O₃.

The arrangement, refractive indices, and thicknesses of coating materials are listed in Table 5 below in order from a substrate.

TABLE 5

| | | Refractive Index (reference | Layer |
|---|---|---|---|
| NO. | Material | wavelength 510 nm) | Thickness(nm) |
| 9 | SiO₂ | 1.4618 | 3.58 |
| 8 | ITO | 2.058 | 36.91 |
| 7 | Al₂O₃ | 1.6726 | 5 |
| 6 | Ag | 0.051 | 15.28 |
| 5 | ITO | 2.058 | 78.88 |
| 4 | Al₂O₃ | 1.6726 | 5 |
| 3 | Ag | 0.051 | 12.42 |
| 2 | ITO | 2.058 | 40.64 |
| 1 | SiO₂ | 1.4618 | 78.7 |
| Substrate | Glass | 1.52077 | |

As shown in Table 5, the multilayer structure may employ four coating materials to a form nine-layer structure. Specifically, the third layer of Ag and the sixth layer of Ag are formed on the second layer of ITO and the fifth layer of ITO, respectively.

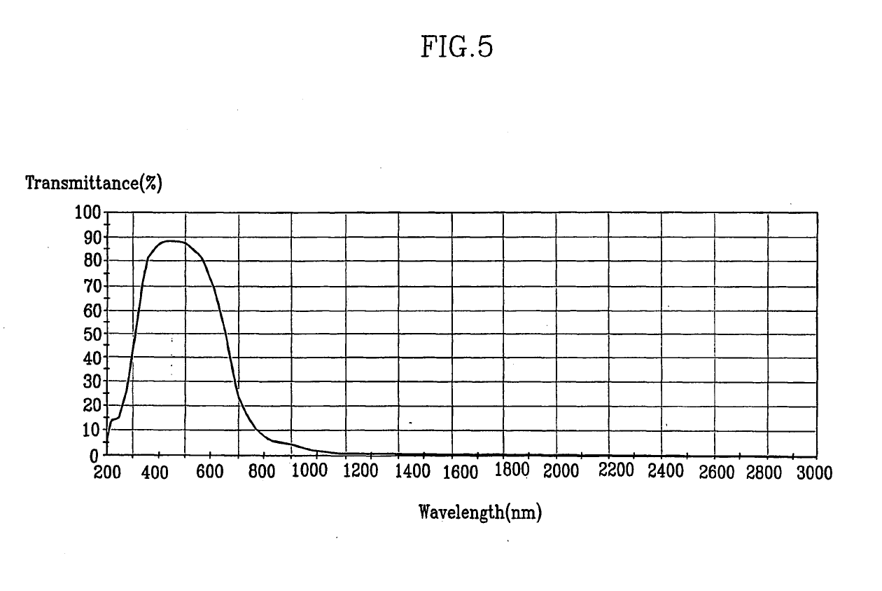

The shading of ultraviolet and infrared light in the multilayer structure is shown FIG. 5, which illustrates a graph of transmission percent of incident light versus the wavelength of the incident light. The multilayer structure transmits about 5% of light having a wavelength of 300 nm to shade ultraviolet light, while it transmits more than 85% of visible light. Further, the transmittance of the structure is about 24% at a wavelength of 800 nm, and is then reduced to less than 4.2% at a wavelength of 1000 nm, resulting in effective shading of the whole infrared range.

### Sixth Embodiment

A multilayer structure for shading ultraviolet and infrared light according to the sixth embodiment of the present invention has ten layers, employing four coating materials such as Ag, ITO, SiO₂, and Al₂O₃.

The arrangement, refractive indices, and thicknesses of coating materials are listed in Table 6 below in order from a substrate.

TABLE 6

| | | Refractive Index (reference | Layer |
|---|---|---|---|
| NO. | Material | wavelength 510 nm) | Thickness(nm) |
| 10 | Al₂O₃ | 1.6726 | 16.21 |
| 9 | ITO | 2.058 | 12.57 |
| 8 | Al₂O₃ | 1.6726 | 23.76 |
| 7 | Ag | 0.051 | 12.29 |
| 6 | ITO | 2.058 | 74.88 |
| 5 | Ag | 0.051 | 11.79 |
| 4 | Al₂O₃ | 1.6726 | 111.82 |
| 3 | Ag | 0.051 | 10.65 |
| 2 | ITO | 2.058 | 40.77 |
| 1 | SiO₂ | 1.4618 | 78.9 |
| Substrate | Glass | 1.52077 | |

As shown in Table 6, the multilayer structure may employ four coating materials to form a ten-layer structure. Specifically, the third layer of Ag is formed on the second layer of ITO, and the sixth layer of ITO is embedded in the fifth layer of Ag and the seventh layer of Ag.

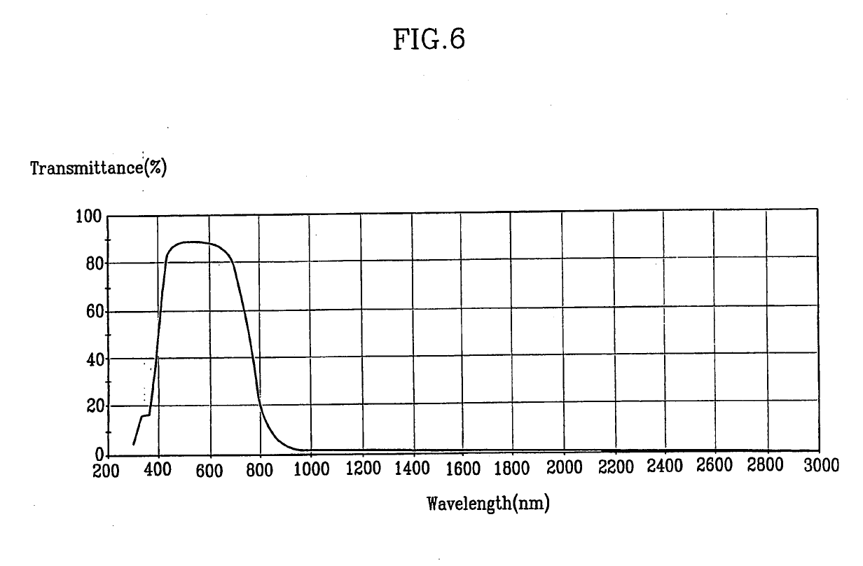

The shading of ultraviolet and infrared light in the multilayer structure is shown in FIG. 6, which illustrates a graph of transmission percent of incident light versus the wavelength of the incident light. The multilayer structure transmits about 4.7% of light having a wavelength of 300 nm, to shade ultraviolet light, while it transmits more than 85% of visible light. Further, the transmittance of the structure is about 21% at a wavelength of 800 nm, and is then reduced less than 1.6% at a wavelength of 1000 nm, resulting in effective shading of the whole infrared range.

The present invention provides the multilayer structure which effectively reflects both infrared and ultraviolet light, while it transmits visible light. The multilayer structure may be employed in various applications such as window glass for vehicles, buildings, or exhibits in museums, in plasma display panels (PDPs), and so forth. The window glass with the multilayer structure may prevent the ambient temperature from rising, and it may protect human skin and avoid decolorization of articles.

Specifically, the multilayer structure may reduce more than 30% of the inside temperature in a vehicle under sunlight in summer time to save fuel. Further, it may even be applied to a front window of a vehicle on which a color plastic sheet may not legally be attached.

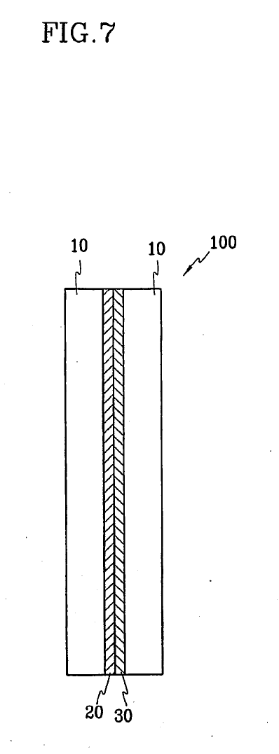

Referring to FIG. 7, a safety glass 100 for vehicles according to the present invention is comprised of two transparent panes 10 of glass or a plastic material, having a plastic film 30 between them. The plastic film 30 is made of plasticized polyvinyl butyral (PVB), and if the glass breaks, the fragments will adhere to the plastic film.

The multilayer structure 20 according to the present invention is formed between one of the panes 10 and the plastic film 30 to effectively shade ultraviolet light and infrared light incident to the inside of the vehicle. Since the multilayer structure 20 is not exposed to the outside, it may be difficult to damage.

It will be apparent to those skilled in the art that various modifications and variations can be made to the present invention without departing from the spirit and scope of the invention.

What is claimed is:

1. A multilayer structure formed on a glass or plastic substrate for shading ultraviolet and infrared light, comprising:
two or three layers of Ag;
two or three layers of indium tin oxide (ITO); and
dielectric oxide layers ranging from two layers to four layers,
wherein at least two Ag layers are formed to be in contact with the ITO layer as an upward or downward layer.

2. The multilayer structure as recited in claim 1, wherein each dielectric oxide layer is made of a material which is selected from SiO₂, TiO₂, Al₂O₃, ZrO₂, Y₂O₃, and Ta₂O₅.

3. The multilayer structure as recited in claim 1, wherein the multilayer structure has seven (7) layers of:
a first layer of SiO₂ formed on the substrate, having a thickness of 162.79 nm and a refractive index of 1.462;
a second layer of ITO formed on the first layer, having a thickness of 38.14 nm and a refractive index of 2.058;
a third layer of TiO₂ formed on the second layer, having a thickness of 126.06 nm and a refractive index of 2.349;
a fourth layer of Ag formed on the third layer, having a thickness of 8.07 nm and a refractive index of 0.051;
a fifth layer of ITO formed on the fourth layer, having a thickness of 84.63 nm and a refractive index of 2.058
a sixth layer of Ag formed on the fifth layer, having a thickness of 14.38 nm and a refractive index of 0.051; and
a seventh layer of ITO formed on the sixth layer, having a thickness of 28.81 nm and a refractive index of 2.349.

4. The multilayer structure as recited in claim 1, wherein the multilayer structure has seven (7) layers of:
a first layer of Ag formed on the substrate, having a thickness of 5.79 nm and a refractive index of 0.051;
a second layer of Y₂O₃ formed on the first layer, having a thickness of 85.56 nm and a refractive index of 1.79581;
a third layer of Ag formed on the second layer, having a thickness of 9.39 nm and a refractive index of 0.051;
a fourth layer of ITO formed on the third layer, having a thickness of 71.91 nm and a refractive index of 2.058;
a fifth layer of Ag formed on the fourth layer, having a thickness of 12.82 nm and a refractive index of 0.051;
a sixth layer of ITO formed on the fifth layer, having a thickness of 36.14 nm and a refractive index of 2.058; and
a seventh layer of Y₂O₃ formed on the sixth layer, having a thickness of 4.08 nm and a refractive index of 1.79581.

5. The multilayer structure as recited in claim 1, wherein the multilayer structure has seven (7) layers of:
a first layer of Ag formed on the substrate, having a thickness of 5.6 nm and a refractive index of 0.051;
a second layer of ZrO₂ formed on the first layer, having a thickness of 63.84 nm and a refractive index of 2.06576;
a third layer of Ag formed on the second layer, having a thickness of 10.05 nm and a refractive index of 0.051;
a fourth layer of ITO formed on the third layer, having a thickness of 76.34, nm and a refractive index of 2.058;
a fifth layer of Ag formed on the fourth layer, having a thickness of 13.07 nm and a refractive index of 0.051;
a sixth layer of ITO formed on the fifth layer, having a thickness of 29.57 nm and a refractive index of 2.058; and
a seventh layer of ZrO₂ formed on the sixth layer, having a thickness of 9.58 nm and a refractive index of 2.06576.

6. The multilayer structure as recited in claim 1, wherein the multilayer structure has eight (8) layers of:
a first layer of SiO₂formed on the substrate, having a thickness of 103.67 nm and a refractive index of 1.4618;
a second layer of ITO formed on the first layer, having a thickness of 34.18 nm and a refractive index of 2.058;
a third layer of Ag formed on the second layer, having a thickness of 10.76 nm and a refractive index of 0.051;
a fourth layer of Ta₂O₅ formed on the third layer, having a thickness of 72.4 nm and a refractive index of 2.14455;
a fifth layer of Ag formed on the fourth layer, having a thickness of 11.06 nm and a refractive index of 0.051;
a sixth layer of ITO formed on the fifth layer, having a thickness of 79.89 nm and a refractive index of 2.058;
a seventh layer of Ag formed on the sixth layer, having a thickness of 13.38 nm and a refractive index of 0.051; and
an eighth layer of Ta₂O₅ formed on the seventh layer, having a thickness of 35 nm and a refractive index of 2.14455.

7. The multilayer structure as recited in claim 1, wherein the multilayer structure has nine (9) layers of:
a first layer of SiO₂ formed on the substrate, having a thickness of 78.7 nm and a refractive index of 1.4618;
a second layer of ITO formed on the first layer, having a thickness of 40.64 nm and a refractive index of 2.058;
a third layer of Ag formed on the second layer, having a thickness of 12.42 nm and a refractive index of 0.051;
a fourth layer of Al₂O₃ formed on the third layer, having a thickness of 5 nm and a refractive index of 1.6726;
a fifth layer of ITO formed on the fourth layer, having a thickness of 78.88 nm and a refractive index of 2.058;
a sixth layer of Ag formed on the fifth layer, having a thickness of 15.28 nm and a refractive index of 0.051;
a seventh layer of Al₂O₃ formed on the sixth layer, having a thickness of 5 nm and a refractive index of 1.6726;
an eighth layer of ITO formed on the seventh layer, having a thickness of 36.91 nm and a refractive index of 2.058; and
a ninth layer of SiO₂ formed on the eighth layer, having a thickness of 3.58 nm and a refractive index of 1.4618.

8. The multilayer structure as recited in claim 1, wherein the multilayer structure hasten (10) layers of:
a first layer of SiO₂ formed on the substrate, having a thickness of 78.9 nm and a refractive index of 1.4618;
a second layer of ITO formed on the first layer, having a thickness of 40.77 nm and a refractive index of 2.058;
a third layer of Ag formed on the second layer, having a thickness of 10.65 nm and a refractive index of 0.051;
a fourth layer of Al₂O₃ formed on the third layer, having a thickness of 111.82 nm and a refractive index of 1.6726;
a fifth layer of Ag formed on the fourth layer, having a thickness of 11.79 nm and a refractive index of 0.051;
a sixth layer of ITO formed on the fifth layer, having a thickness of 74.88 nm and a refractive index of 2.058;
a seventh layer of Ag formed on the sixth layer, having a thickness of 12.29 nm and a refractive index of 0.051;
an eighth layer of Al₂O₃ formed on the seventh layer, having a thickness of 23.76 nm and a refractive index of 1.6726;
a ninth layer of ITO formed on the eighth layer, having a thickness of 12.57 nm and a refractive index of 2.058; and
a tenth layer of Al₂O₃ formed on the ninth layer, having a thickness of 16.21 nm and a refractive index of 1.6726.

9. An article comprising the structure of claim 1 applied to a surface of a glass or plastic substrate.

10. A window construction for ultraviolet and infrared shading comprising:
a substrate of glass or plastic material;
two or three layers of Ag;
two or three layers of indium tin oxide (ITO); and
dielectric oxide layers ranging from two layers to four layers,
wherein at least two Ag layers are formed to be in contact with the ITO layer as an upward or downward layer.

11. The window construction as recited in claim 10, wherein each dielectric oxide layer is made of a material which is selected from SiO₂, TiO₂, Al₂O₃, ZrO₂, Y₂O₃, and Ta₂O₅.

12. A safety glass comprising:
two transparent panes made of glass or plastic material;
a plastic sheet adhered between the two transparent panes, preventing the panes from shattering; and
an optical coating formed on at least one of the transparent panes against the plastic sheet, for shading ultraviolet and infrared light, comprising:
two or three layers of Ag;
two or three layers of indium tin oxide (ITO); and
dielectric oxide layers ranging from two layers to four layers,
wherein at least two Ag layers are formed to be in contact with the ITO layer as an upward or downward layer.

13. The safety glass as recited in claim 12, wherein each dielectric oxide layer is made of a material which is selected from SiO₂, TiO₂, Al₂O₃, ZrO₂, Y₂O₃ and Ta₂O₅.
